(19) United States
(12) Patent Application Publication
(10) Pub. No.: US 2016/0036334 A1
(43) Pub. Date: Feb. 4, 2016

(54) ELECTRONIC APPARATUS, POWER SUPPLY AND POWER CONTROL METHOD THEREOF

(71) Applicant: SAMSUNG ELECTRONICS CO., LTD., Suwon-si (KR)

(72) Inventor: Jeong-il KANG, Yongin-si (KR)

(73) Assignee: SAMSUNG ELECTRONICS CO., LTD., Suwon-si (KR)

(21) Appl. No.: 14/798,930

(22) Filed: Jul. 14, 2015

(30) Foreign Application Priority Data
Aug. 1, 2014 (KR) 10-2014-0099010

(51) Int. Cl. H02M 3/335

(52) U.S. Cl. CPC H02M 3/33507

(57) ABSTRACT

An electronic apparatus including a power supply, the power supply including: first and second switches configured to perform a switching operation in response to a control signal; a transformer including a primary winding which is provided with a tap and a secondary winding to which voltage from the primary winding is induced, and configured to operate at least a portion of the primary winding to apply a voltage to the secondary winding in response to the switching operation of one of the first switch and the second switch; and a controller configured to output a control signal so that one of the first switch and the second switch can perform the switching operation in accordance with an operation mode of the electronic apparatus.

### CROSS-REFERENCE TO RELATED APPLICATION

This application claims priority from Korean Patent Application No. 10-2014-0099010, filed on Aug. 1, 2014, in the Korean Intellectual Property Office, the disclosure of which is incorporated herein by reference in its entirety.

### BACKGROUND

1. Field

Apparatuses and methods consistent with one or more exemplary embodiments relate to an electronic apparatus, a power supply, and a power control method thereof, and more particularly to an electronic apparatus, a power supply, and a power control method thereof, in which an efficiency of the power supply is improved in accordance with operation modes of the electronic apparatus.

2. Description of Related Art

An electronic apparatus including a display apparatus such as a television (TV) may be provided with a power supply for supplying power needed for operations.

The electronic apparatus may have a plurality of power modes. In related art, operation modes of a product have been divided into an ON mode and an OFF mode, but have recently included an additional mode in which the product may be partially turned on to selectively operate a certain function.

For example, a set-top box for receiving a cable broadcast may have a SEMI-ON mode in addition to the ON mode and the OFF mode. In the SEMI-ON mode, functions for receiving the broadcast do not operate but some functions are operated for receiving information from a cable broadcaster. In the ON mode, functions are all normally operated. In the OFF mode, all the functions are disabled.

Further, a display apparatus connected to an information network may have a SEMI-ON mode in which some functions are operated for transmitting and receiving various pieces of data.

Typically, the power supply of the electronic apparatus is designed to have the maximum efficiency in the ON mode in which all the functions are enabled.

FIG. 1 is a circuit diagram of a related art power supply using a flyback converter, and FIG. 2 is a graph showing a general efficiency due to load in the power supply.

As shown in FIG. 1, the related art power supply includes a switching element M1 that receives a control signal and performs a switching operation, a transformer T1 that applies a voltage to a secondary side in response to the switching operation, and a control integrated circuit (IC) that outputs the control signal to the switching element M1.

In general, a switching element M1 having higher capacity is used as a capacity of the power supply increases. To make the capacity of the transformer T1 higher, a transformer core becomes bigger and a primary inductance becomes smaller. As the capacity of the switching element increases, the control IC uses more power to drive the switching element and a parasitic capacitance component of the switching element increases, thereby increasing a switching loss. In the case of the transformer, the bigger core causes a higher hysteresis loss, and the lower inductance of the transformer increases a peak value and an effective value of current flowing in the switch, thereby increasing the switching loss and increasing a conductive loss in a winding wire of the transformer.

Thus, the related art power supply shown in FIG. 1 has a problem in that an efficiency of a power circuit becomes lower as the loss in the switching element and the transformer increases due to the decrease in a load in comparison to the maximum designed efficiency of the power circuit. FIG. 2 shows a general pattern of an efficiency that the power supply has for different levels of loads, in which the power supply has a low efficiency in a light load.

Accordingly, there is a need for improving the efficiency of the power supply in the light load.

To accomplish this, a method of lowering a switching frequency in the light load has been attempted. However, this method has many side effects, such as ripples arising in an output voltage and current, the conductive loss increases in an output terminal filter, a response characteristic of the circuit is slow, audible noise is likely to occur, and so on. Thus, it has too many shortcomings to be applied to the power supply.

In addition, a separate power circuit corresponding to the light load may be taken into account. However, such a separate circuit raises costs of the power circuit and fails to keep up with the latest trend of miniaturizing and making the product weigh less.

### SUMMARY

According to an aspect of an exemplary embodiment, there is provided an electronic apparatus including a power supply, the power supply including: a first switch and a second switch, each configured to perform a switching operation in response to a control signal; a transformer including a primary winding, which is provided with a tap, and a secondary winding to which voltage from the primary winding is induced, and is configured to operate at least a portion of the primary winding to apply a voltage to the secondary winding in response to the switching operation of one of the first switch and the second switch; and a controller configured to output a control signal so that one of the first switch and the second switch performs the switching operation in accordance with an operation mode of the electronic apparatus.

The first switch may be connected to the tap of the primary winding, and in response to the first switch performing the switching operation, a portion of the primary winding corresponding to the number of wire turns from one end of the primary winding to the tap may be operated.

The second switch may be connected to an other end of the primary winding, and in response to the second switch performing the switching operation, the whole of the primary winding corresponding to a total number of wire turns may be operated.

The controller may be further configured to output the control signal such that, under a heavy load condition, the first switch may be configured to operate, and under a light load condition, the second switch may be configured to operate.

The second switch may have a smaller capacity than the first switch.

The first switch may include a switching element having a high capacity determined according to a maximum load condition, and the second switch may include a switching element having a low capacity determined according to a predetermined light load condition.

The controller may include: a control block configured to output a mode selection signal corresponding to the operation mode; and an output including a first output terminal connected to the first switch and a second output terminal connected to the second switch, and configured to output the control signal to one of the first output terminal and the second output terminal according to the mode selection signal received from the control block.

The operation mode may include an ON mode corresponding to a heavy load and a SEMI-ON mode corresponding to a light load.

According to an aspect of another exemplary embodiment, there is provided a power supply including: a first switch and a second switch, each configured to perform a switching operation in response to a control signal; a transformer including a primary winding, which is provided with a tap, and a secondary winding to which voltage from the primary winding is induced, and is configured to operate at least a portion of the primary winding to apply a voltage to the secondary winding in response to the switching operation of one of the first switch and the second switch; and a controller configured to output a control signal so that one of the first switch and the second switch performs the switching operation in accordance with an operation mode of the electronic apparatus.

The first switch may be connected to the tap of the primary winding, and in response to the first switch performing the switching operation, a portion of the primary winding corresponding to the number of wire turns from one end of the primary winding to the tap may be operated.

The second switch may be connected to an other end of the primary winding, and in response to the second switch performing the switching operation, the whole of the primary winding corresponding to a total number of wire turns may be operated.

The controller may be further configured to output the control signal such that, under a heavy load condition, the first switch may be configured to operate, and under a light load condition, the second switch may be configured to operate.

The second switch may have a smaller capacity than the first switch.

The first switch may include a switching element having a high capacity determined according to a maximum load condition, and the second switch may include a switching element having a low capacity determined according to a predetermined light load condition.

The controller may include: a control block configured to output a mode selection signal corresponding to the operation mode; and an output including a first output terminal connected to the first switch and a second output terminal connected to the second switch, and configured to output the control signal to one of the first output terminal and the second output terminal according to the mode selection signal received from the control block.

The operation mode may include an ON mode corresponding to a heavy load and a SEMI-ON mode corresponding to a light load.

The power supply may include a rectifying diode configured to rectify a current at a secondary side of the transformer; and a capacitor configured to smooth a voltage passed through the rectifying diode.

According to an aspect of another exemplary embodiment, there is provided a power control method of an electronic apparatus that includes a system for performing operations and a power supply for supplying power to the system, the power control method including: outputting a control signal corresponding to an operation mode of the electronic apparatus; performing a switching operation through one of a first switch and a second switch according to the control signal; operating, by a transformer including a primary winding and a secondary winding, at least a portion of the primary winding provided with a tap in response to the switching operation of one of the first switch and the second switch; applying a voltage to the secondary winding of the transformer; and supplying the applied voltage to the system.

The first switch may be connected to the tap of the primary winding, and the operating at least a portion of the primary winding may include operating a portion of the primary winding corresponding to the number of wire turns from one end of the primary winding to the tap in response to the first switch performing the switching operation.

The second switch may be connected to an other end of the primary winding, and the operating the primary winding may include operating the whole of the primary winding corresponding to a total number of wire turns in response to the second switch performing the switching operation.

The outputting the control signal may include outputting the control signal to operate the first switch under a heavy load condition and to operate the second switch under a light load condition.

The second switch may have a smaller capacity than the first switch.

The operation mode may include an ON mode corresponding to a heavy load and a SEMI-ON mode corresponding to a light load.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a circuit diagram of a related art power supply using a flyback converter;

FIG. 2 is a graph showing a general pattern of an efficiency that a power supply has in accordance with a load;

FIG. 3 is a block diagram of an electronic apparatus according to an exemplary embodiment;

FIG. 4 is a graph showing power consumption in operation modes of the electronic apparatus according to an exemplary embodiment;

FIG. 5 is a circuit diagram of a power supply in FIG. 3 according to an exemplary embodiment;

FIG. 6 shows an internal configuration of a controller in FIG. 5 according to an exemplary embodiment;

FIGS. 7 and 8 show circuit connections when the power supply of FIG. 5 is in an ON mode and a SEMI-ON mode, respectively, according to an exemplary embodiment; and

FIG. 9 is a flowchart showing a power control method of an electronic apparatus according to an exemplary embodiment.

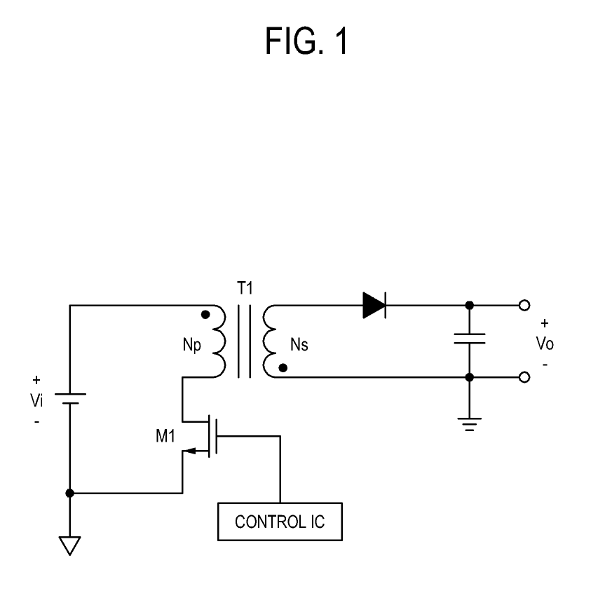

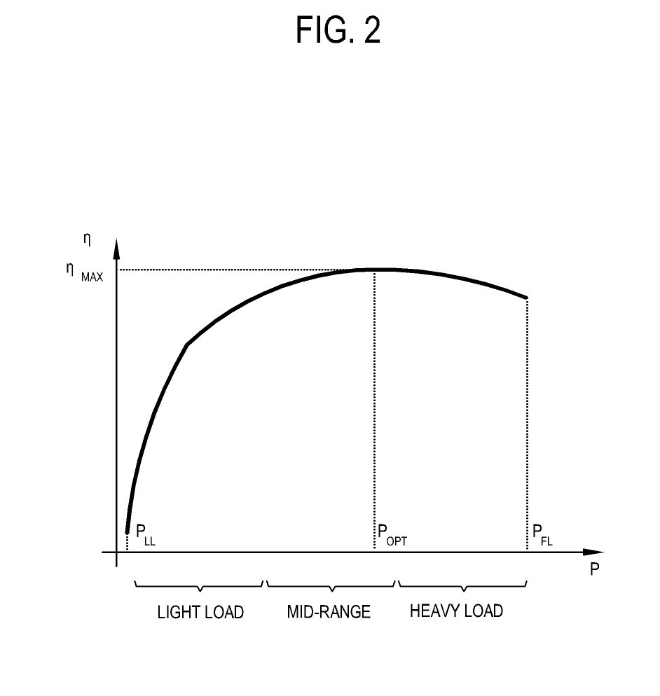

### DETAILED DESCRIPTION

Below, one or more exemplary embodiments will be described in detail with reference to accompanying drawings.

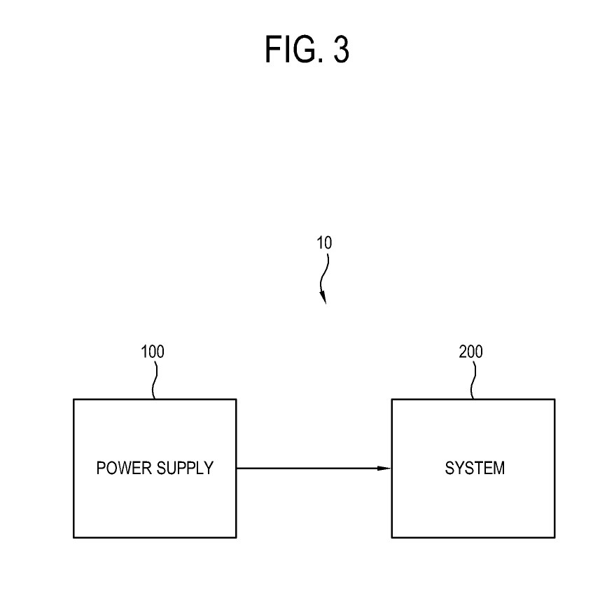

FIG. 3 is a block diagram showing an electronic apparatus according to an exemplary embodiment.

The electronic apparatus 10 may be achieved by a display apparatus such as a television (TV), a monitor, etc.; a set-top box for receiving a broadcast signal; a portable terminal such as an MP3 player, a mobile phone, etc.; a computer such as a desktop computer, a laptop computer, etc.

As shown in FIG. 3, the electronic apparatus 10 may include a power supply 100 that supplies power to a system 200, which performs operations.

The system 200 performs the operations of the electronic apparatus 10. For example, if the electronic apparatus 10 is a display apparatus, the system 200 processes an image signal received from an external image source in accordance with a preset image processing process and displays an image based on the processed image signal. The system 200 may include an image processor to process an image signal, a display to display an image based on the image signal, a communicator to communicate with the exterior, a storage to store various pieces of data, and a central processing unit (CPU) to control the display apparatus.

The system 200 operates by receiving power from the power supply 100, and performs the operations corresponding to a plurality of operation modes.

In order to perform the operations corresponding to a plurality of operation modes in an exemplary embodiment, the electronic apparatus 10 may have an ON mode in which all of the functions thereof are normally enabled, a SEMI-ON mode in which some elements are turned on to enable only certain preset functions, and an OFF mode in which all of the functions are disabled.

For example, in the SEMI-ON mode, the set-top box may enable a cable modem to receive information from a cable broadcaster, a radio signal, or the like. In the SEMI-ON mode, the display apparatus (e.g., a TV) may enable a communication module to transmit and receive various pieces of data and/or partially enable the display to display information. Such operations performed in the SEMI-ON mode may be set by a manufacturer by default, or set by a user.

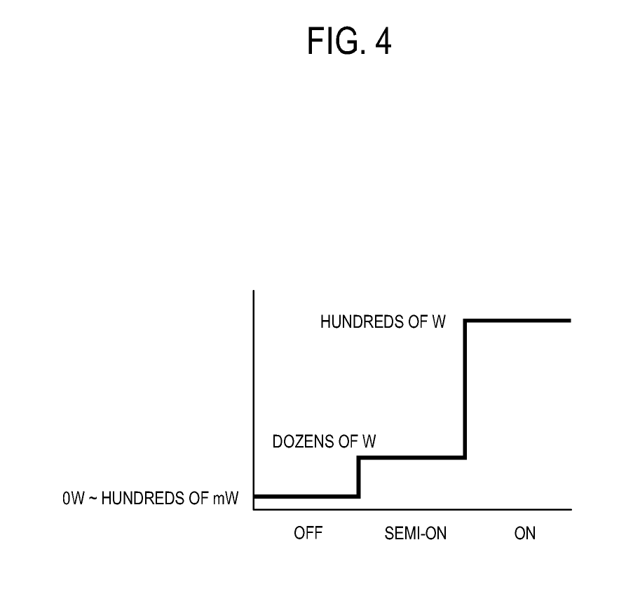

FIG. 4 is a graph showing an example of power consumption in the operation modes of the electronic apparatus according to an exemplary embodiment;

As shown in FIG. 4, the power consumption in the OFF mode ranges from 0 watts (W) to hundreds of mW, the power consumption in the SEMI-ON mode reaches dozens of W, and the power consumption in the ON mode, in which all the functions are enabled, increases up to hundreds of W.

In an exemplary embodiment, the power supply 100 can efficiently operate with a low loss in both the SEMI-ON mode and the ON mode, which consume different amounts of power.

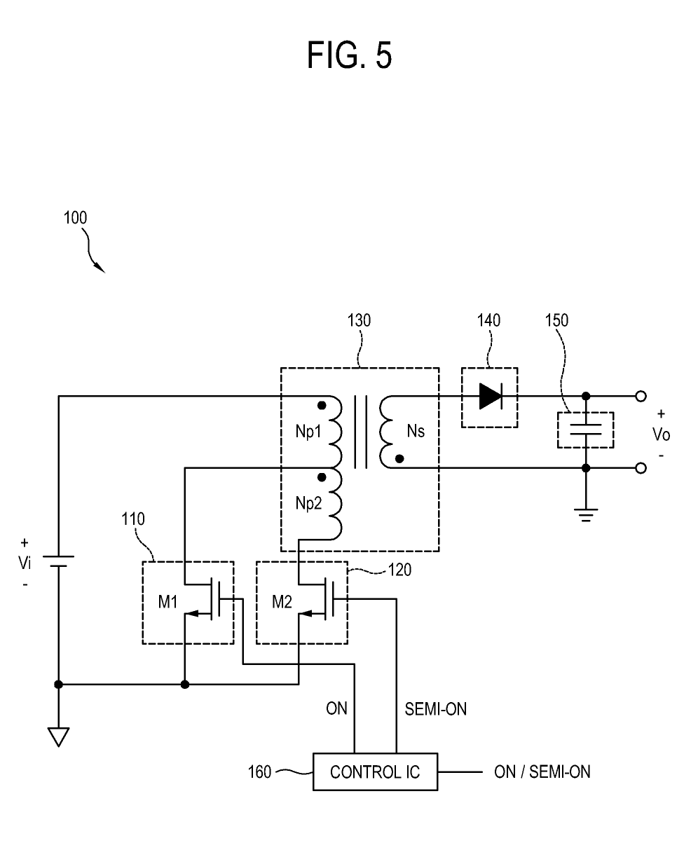

The power supply 100 supplies at least a part of the power supplied to the system 200. In an exemplary embodiment, the power supply 100 may be achieved by a flyback converter circuit, as shown in FIG. 5.

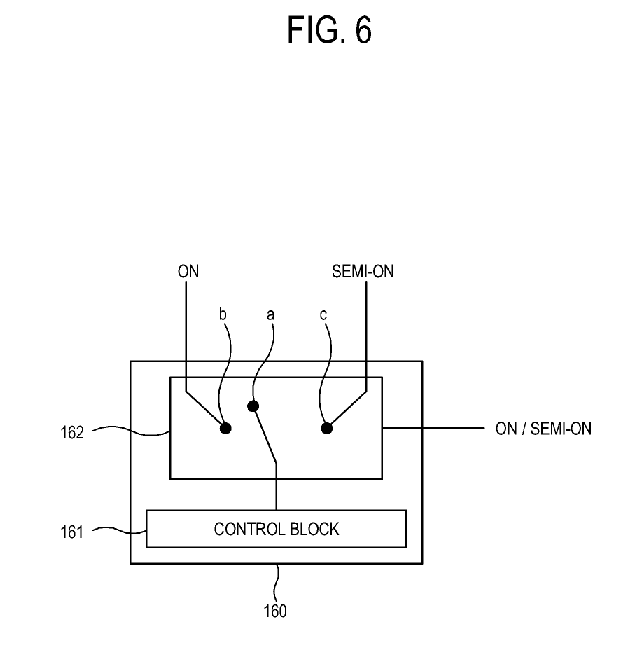

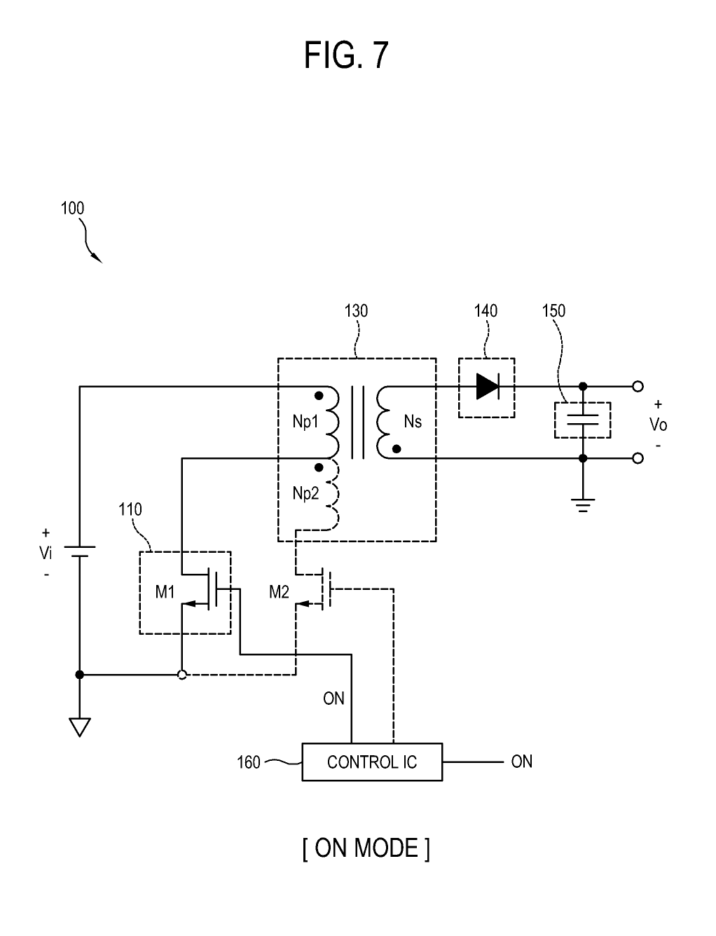

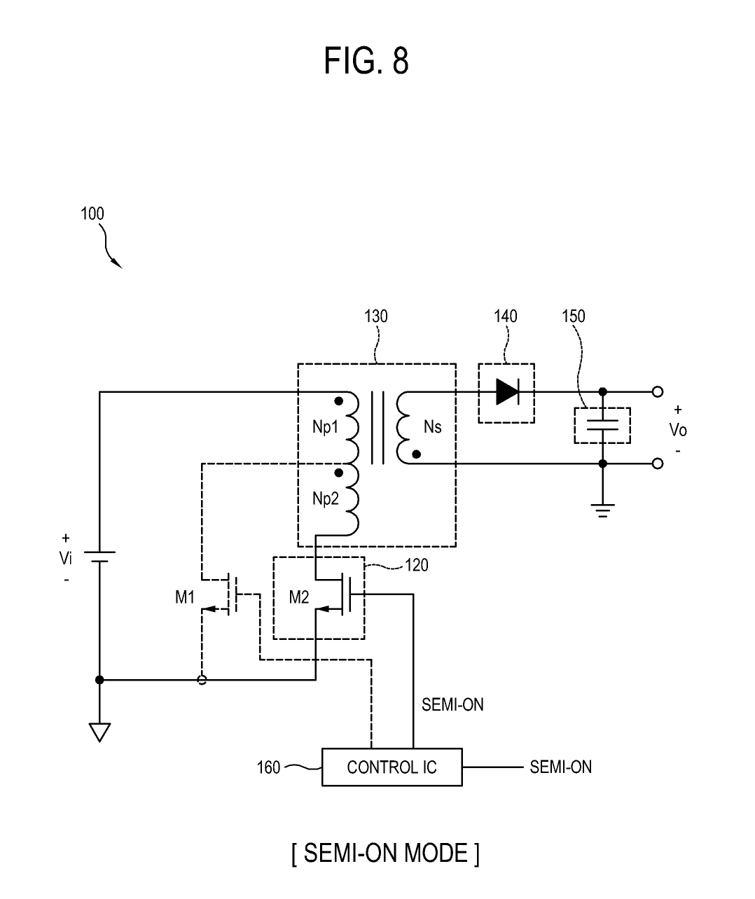

FIG. 5 is a circuit diagram of an exemplary power supply of FIG. 3, FIG. 6 shows an internal configuration of an exemplary controller of FIG. 5, and FIGS. 7 and 8 show circuit connections when an exemplary power supply of FIG. 5 is in an ON mode and a SEMI-ON mode, respectively.

As shown in FIG. 5, the power supply 100 includes first and second switches M1, 110, and M2, 120, which perform switching operations in response to a control signal of a controller 160; a transformer T1, 130, which applies voltage from a primary side to a secondary side in response to the switching operation of one of the first switch M1, 110, and the second switch M2, 120; a rectifying diode 140, which rectifies a current at the secondary side of the transformer; a capacitor 150 which smoothes a voltage passed through the rectifying diode 140; and a controller 160 which outputs the control signal so that one of the first switch M1, 110, and the second switch M2, 120, can perform the switching operation in accordance with the operation modes of the electronic apparatus 10.

The controller 160 selectively drives the first switch M1, 110, and the second switch M2, 120, in accordance with load conditions. In an exemplary embodiment, the controller 160 may be achieved by a control IC in which circuit elements are integrated.

As shown in FIG. 6, the controller 160 includes a control block 161, which outputs a mode selection signal corresponding to the operation mode; an input terminal “a” (ON/SEMI-ON) for receiving the mode selection signal; and an output 162 including first and second output terminals “b” and “c,” ON and SEMI-ON, respectively connected to the first and second switches M1, 110, and M2, 120.

The control block 161 determines the operation mode of the system 200, and outputs the mode selection signal corresponding to the determined operation mode (e.g., an ON mode signal or a SEMI-ON mode signal). The control block 161 may receive a signal representing the operation mode from the central processing unit (CPU) of the system 200.

The mode selection signal is achieved by a high or low signal. For example, if the ON mode signal is set to the high signal, then the SEMI-ON mode signal is the low signal. However, the mode selection signal is not limited to this. Alternatively, the ON mode signal may be set to the low signal and the SEMI-ON mode signal may be set to the high signal.

The output 162 determines the ON mode or the SEMI-ON mode based on the mode selection signal (high or low) received from the control block 161, and outputs the control signal for switching to one of the first output terminal “b” and the second output terminal “c.” That is, the output 161 selectively outputs the control signal for switching operation to one of an ON pin b and a SEMI-ON pin c.

Referring to FIGS. 5, 7 and 8, the power supply 100 in an exemplary embodiment enables the first switch M1 110, in a heavy load condition, e.g., the ON mode, and enables the second switch M2, 120, in a light load condition, e.g., the SEMI-ON mode in accordance with a control signal from the controller 160.

The transformer 130 includes a primary winding (hereinafter, referred to as a primary coil), and a secondary winding (hereinafter, referred to as a secondary coil) which has a predetermined turn ratio to the primary winding, and to which voltage from the primary winding is induced. The primary winding is provided with a tap (hereinafter, referred to as an intermediate tap) connected to the first switch M1, 110.

The first switch M1, 110, performs the switching operation in response to a predetermined frequency, and may be achieved by a switching element having a high capacity determined according to the maximum load condition of the system 200. The capacity of the first switch M1, 110, is designed to have a high efficiency in the ON mode in which all the functions of the electronic apparatus 10 are enabled.

As shown in FIG. 7, in the ON mode, the transformer 130 operates at a portion of the primary winding, which corresponds to the number of winding wire Np1 from one end of the primary winding to the tap, in response to the switching operation of the first switch M1, 110.

In an exemplary embodiment, the first switch M1, 110, of the high capacity has a gate having high capacitance and therefore consumes much power in the switching operation. The output capacitance of the first switch M1, 110, is also high, causing a relatively high switching loss due to the on/off operations of the switching element. However, in the ON mode, all the functions of the electronic apparatus 10 are enabled, and thus the output power of the power supply 100 is high, thereby decreasing a proportion of this loss. Accordingly, the circuit 100 operates at the optimum efficiency.

The second switch M2, 120, is connected to the other end of the primary winding and performs the switching operation in response to a predetermined frequency. The second switch M2, 120, has a smaller capacity than the first switch M1, 110, and may be achieved by a switching element having a low capacity determined according to the light load condition of the system 200. In an exemplary embodiment, the capacity of the second switch M2, 120, is designed to have a high efficiency in the SEMI-ON mode in which some functions (e.g., data communication, or the like) of the electronic apparatus 10 are enabled. The light load condition may be previously determined based on the functions to be performed in the SEMI-ON mode.

As shown in FIG. 8, in the SEMI-ON mode, the transformer 130 operates at the whole of the primary winding, which corresponds to the total number of winding wire Np1+Np2 of the primary winding, in response to the switching operation of the second switch M2, 120.

In this embodiment, the second switch M2, 120, of the low capacity has a gate having low capacitance and therefore consumes relatively less power in the switching operation, and the output capacitance of the second switch M2, 120, is also low, thereby causing a relatively low switching loss due to the on/off operations of the switching element. Further, the primary winding of the transformer 130 has a higher number of wire turns than in the ON mode, and therefore inductance increases in proportion to the square of the number of wire turns by comparison to the ON mode. Accordingly, current ripples are decreased in inverse proportion to the inductance, and the core loss of the transformer 130 is also decreased in inverse proportion to the number of wire turns. Therefore, it should be appreciated that the power supply 100 operates at a sufficiently high efficiency even under the light load condition.

As a result, using P=V2/R, it should be appreciated that energy loss is decreased since the power consumed in the SEMI-ON mode in which a load is light does not increase under the same output voltage V0.

In an exemplary embodiment, the electronic apparatus 10 has three operation modes of the ON mode, the SEMI-ON mode, and the OFF mode, but it is not limited thereto. For example, the SEMI-ON mode may be subdivided into two or more modes in accordance with functions, and thus the electronic apparatus 10 may have four or more operation modes. If the SEMI-ON mode is subdivided into a plurality of modes, the power supply 100 may additionally include an intermediate tap to the primary winding of the transformer 130, and a switching element connected to the intermediate tap so that power can be supplied corresponding to the load of each mode.

Accordingly, any transformer may be applied to the power supply 100 according to an exemplary embodiment, as long as the transformer includes one or more taps and one or more switches connected to the corresponding taps so that one of the switches can operate in accordance with respective modes.

As described above, the power supply 100 according to an exemplary embodiment adds the tap to the transformer 130, and uses the switch 120 of a low capacity, thereby having a high efficiency in not only the heavy load but also the light load. Accordingly, it will be expected that a power efficiency of the power supply 100 can be improved with low costs.

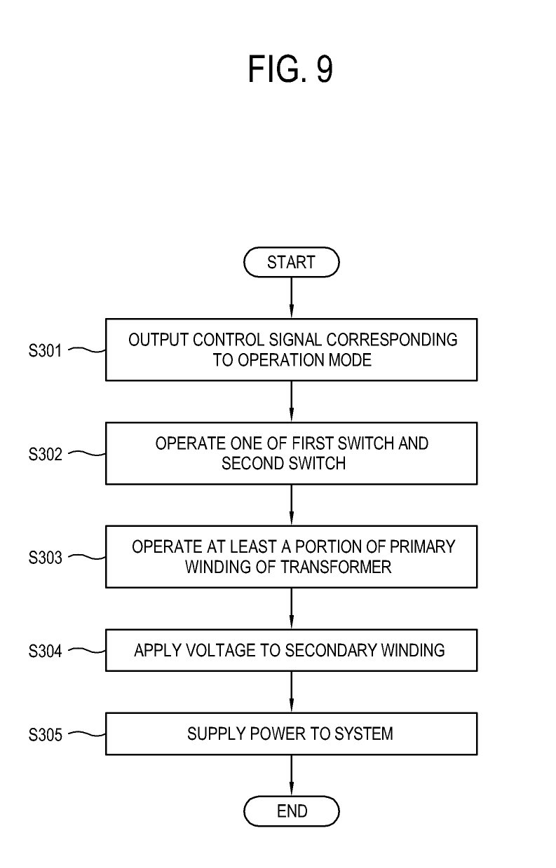

Below, a power control method of the electronic apparatus 10 according to an exemplary embodiment will be described with reference to FIG. 9.

FIG. 9 is a flowchart showing a power control method of an electronic apparatus according to an exemplary embodiment.

As shown in FIG. 9, the controller 160 of the electronic apparatus 10 according to an exemplary embodiment outputs the control signal corresponding to the operation mode of the system 200 (S301). The control block 161 of the controller 160 outputs a high signal as the mode selection signal to the output 162 if the operation mode is the ON mode, and outputs a low signal as the mode selection signal to the output 162 if the operation mode is the SEMI-ON mode. The output 162 connects the input terminal “a” with a corresponding terminal among the plurality of output terminals “b” and “c.” For example, if the high signal is received in the output 162, the input terminal “a” connects with the first output terminal “b” corresponding to the ON mode so that the control signal can be output to the first switch 110.

In response to the control signal output in operation S301, one of the first switch 110 and the second switch 120 performs the switching operation (S302). If the high signal is output as the mode selection signal in operation S301 and the input terminal “a” connects with the first output terminal “b,” the first switch 110 performs the switching operation. On the other hand, if the low sigma is output as the mode selection signal in operation S301 and the input terminal “a” connects with the second output terminal “c,” the second switch 120 performs the switching operation.

By the switching operation in operation S302, at least a portion of the primary winding of the transformer 130 operates (S303). If the first switch 110 operates in operation S302, a portion Np1 of the primary winding is used. On the other hand, if the second switch 120 operates, the whole of the primary winding Np1+Np2 is used.

In operation S303, the voltage at the primary side of the transformer 130 is applied to the secondary side (S304).

Then, the power V0 is supplied to the system 200 via the rectifying diode 140 and the capacitor 150 (S305).

Thus, the power supply 100 according to an exemplary embodiment is achieved by providing the intermediate tap in the transformer 130 of an existing power supply and adding the switch 120 of the small capacity, so that the power supply 100 can have a high efficiency in not only the heavy load condition but also the light load condition.

Accordingly, the power supply 100 according to an exemplary embodiment or the electronic apparatus 10 including the power supply 100 does not have to change a switching frequency in accordance with loads; is free from side effects of the existing circuit, which lowers a low efficiency of switching ripples in a light load, response speed, etc.; minimizes additional components to prevent costs from unnecessarily increasing; and improves an efficiency of a power circuit in the light load condition.

Although a few exemplary embodiments have been shown and described, it should be appreciated by those skilled in the art that changes may be made in the exemplary embodiments without departing from the principles and spirit of the inventive concepts, the scope of which is defined in the appended claims and their equivalents.

What is claimed is:

1. An electronic apparatus comprising a power supply,
wherein the power supply comprises:
a first switch and a second switch, each configured to perform a switching operation in response to a control signal;
a transformer comprising a primary winding, which is provided with a tap, and a secondary winding to which voltage from the primary winding is induced, and is configured to operate at least a portion of the primary winding to apply a voltage to the secondary winding in response to the switching operation of one of the first switch and the second switch; and
a controller configured to output a control signal so that one of the first switch and the second switch performs the switching operation in accordance with an operation mode of the electronic apparatus.

2. The electronic apparatus according to claim 1, wherein the first switch is connected to the tap of the primary winding, and in response to the first switch performing the switching operation, a portion of the primary winding corresponding to the number of wire turns from one end of the primary winding to the tap is operated.

3. The electronic apparatus according to claim 2, wherein the second switch is connected to an other end of the primary winding, and in response to the second switch performing the switching operation, the whole of the primary winding corresponding to a total number of wire turns is operated.

4. The electronic apparatus according to claim 1, wherein the controller is further configured to output the control signal such that, under a heavy load condition, the first switch is configured to operate, and under a light load condition, the second switch is configured to operate.

5. The electronic apparatus according to claim 4, wherein the second switch has a smaller capacity than the first switch.

6. The electronic apparatus according to claim 4, wherein the first switch comprises a switching element having a high capacity determined according to a maximum load condition, and the second switch comprises a switching element having a low capacity determined according to a predetermined light load condition.

7. The electronic apparatus according to claim 1, wherein the controller comprises:
a control block configured to output a mode selection signal corresponding to the operation mode; and
an output comprising a first output terminal connected to the first switch and a second output terminal connected to the second switch, and configured to output the control signal to one of the first output terminal and the second output terminal according to the mode selection signal received from the control block.

8. The electronic apparatus according to claim 7, wherein the operation mode comprises an ON mode corresponding to a heavy load and a SEMI-ON mode corresponding to a light load.

9. A power supply comprising:
a first switch and a second switch, each configured to perform a switching operation in response to a control signal;
a transformer comprising a primary winding, which is provided with a tap, and a secondary winding to which voltage from the primary winding is induced, and is configured to operate at least a portion of the primary winding to apply a voltage to the secondary winding in response to the switching operation of one of the first switch and the second switch; and
a controller configured to output a control signal so that one of the first switch and the second switch performs the switching operation in accordance with an operation mode of the electronic apparatus.

10. The power supply according to claim 9, wherein the first switch is connected to the tap of the primary winding, and in response to the first switch performing the switching operation, a portion of the primary winding corresponding to the number of wire turns from one end of the primary winding to the tap is operated.

11. The power supply according to claim 10, wherein the second switch is connected to an other end of the primary winding, and in response to the second switch performing the switching operation, the whole of the primary winding corresponding to a total number of wire turns is operated.

12. The power supply according to claim 9, wherein the controller is further configured to output the control signal such that, under a heavy load condition, the first switch is configured to operate, and under a light load condition, the second switch is configured to operate.

13. The power supply according to claim 12, wherein the second switch has a smaller capacity than the first switch.

14. The power supply according to claim 12, wherein the first switch comprises a switching element having a high capacity determined according to a maximum load condition, and the second switch comprises a switching element having a low capacity determined according to a predetermined light load condition.

15. The power supply according to claim 9, wherein the controller comprises:
a control block configured to output a mode selection signal corresponding to the operation mode; and
an output comprising a first output terminal connected to the first switch and a second output terminal connected to the second switch, and configured to output the control signal to one of the first output terminal and the second output terminal according to the mode selection signal received from the control block.

16. The power supply according to claim 15, wherein the operation mode comprises an ON mode corresponding to a heavy load and a SEMI-ON mode corresponding to a light load.

17. The power supply according to claim 9, further comprising:
a rectifying diode configured to rectify a current at a secondary side of the transformer; and
a capacitor configured to smooth a voltage passed through the rectifying diode.

18. A power control method of an electronic apparatus that comprises a system for performing operations and a power supply for supplying power to the system, the power control method comprising:
outputting a control signal corresponding to an operation mode of the electronic apparatus;
performing a switching operation through one of a first switch and a second switch according to the control signal;
operating, by a transformer comprising a primary winding and a secondary winding, at least a portion of the primary winding provided with a tap in response to the switching operation of one of the first switch and the second switch;
applying a voltage to the secondary winding of the transformer; and
supplying the applied voltage to the system.

19. The power control method according to claim 18, wherein the first switch is connected to the tap of the primary winding, and
the operating at least a portion of the primary winding comprises operating a portion of the primary winding corresponding to the number of wire turns from one end of the primary winding to the tap in response to the first switch performing the switching operation.

20. The power control method according to claim 19, wherein the second switch is connected to an other end of the primary winding, and
the operating the primary winding comprises operating the whole of the primary winding corresponding to a total number of wire turns in response to the second switch performing the switching operation.

21. The power control method according to claim 19, wherein the outputting the control signal comprises outputting the control signal to operate the first switch under a heavy load condition and to operate the second switch under a light load condition.

22. The power control method according to claim 21, wherein the second switch has a smaller capacity than the first switch.

23. The power control method according to claim 18, wherein the operation mode comprises an ON mode corresponding to a heavy load and a SEMI-ON mode corresponding to a light load.
